(19) United States
(12) Patent Application Publication
(10) Pub. No.: US 2018/0034780 A1
(43) Pub. Date: Feb. 1, 2018

(54) GENERATION OF ASSET DATA USED IN CREATING TESTING EVENTS

(71) Applicant: International Business Machines Corporation, Armonk, NY (US)

(72) Inventors: Rory F. Bray, Keswick Ridge (CA); Christopher I. Collins, Fredericton (CA); Michael S. Hume, New Maryland (CA); Jasna Jackson, Beaver Dam (CA); Steven W. R. Jones, Burtts Corner (CA); Christopher A. Lemesurier, Fredericton (CA)

(21) Appl. No.: 15/220,660

(22) Filed: Jul. 27, 2016

(51) Int. Cl. H04L 29/06

(52) U.S. Cl. CPC H04L 63/0263; H04L 63/20; H04L 63/1433

(57) ABSTRACT

In an approach, a processor receives information from a computing device, wherein the information comprises normalized device configuration files, topology records, and telemetry data. A processor evaluates the information for asset data, routing information, traffic processing rules, and firewall rules. A processor generates a plain text asset data file, wherein the asset data file comprises an asset record for each possible asset. A processor creates, based on the generated plain asset data file, a testing event. A processor runs the testing event.

### BACKGROUND

The present invention relates generally to the field of security information and event management systems, and more particularly to generating asset data that successfully replicates a network for testing and support purposes.

Security information and event management (SIEM) systems centralize the relevant data about a business's network security, which allows for easier spotting of trends and patterns that are out of the ordinary. A SIEM system uses collection agents to gather security-related events from end-user devices, servers, and network equipment—such as firewalls, antivirus, or intrusion prevention systems. The collection agents forward events to a centralized management console, which performs inspections and flags anomalies. To allow a SIEM system to adequately complete network and software testing, it is essential for the SIEM service to create a profile replicating the business's network under normal event conditions. To replicate the business's network, the SIEM service needs information about the assets connected to the network, a replay of network traffic, and an export of event traffic.

### SUMMARY

According to one embodiment of the present invention, a method for generating asset data for network replication is provided. The method includes a processor receiving information from a computing device; a processor evaluating the information for asset data, routing information, traffic processing rules, and firewall rules; a processor generating a plain text asset data file, wherein the asset data file comprises an asset record for each possible asset; a processor creating, based on the generated plain asset data file, a testing event; and a processor running the testing event.

According to another embodiment of the present invention, a computer program product for generating asset data for network replication is provided. The computer program product comprises a computer readable storage medium and program instructions stored on the computer readable storage medium. The program instructions include program instructions to receive information from a computing device; evaluate the information for asset data, routing information, traffic processing rules, and firewall rules; generate a plain text asset data file, wherein the asset data file comprises an asset record for each possible asset; create, based on the generated plain asset data file, a testing event; and run the testing event.

According to another embodiment of the present invention, a computer system for generating asset data for network replication is provided. The computer system includes one or more computer processors, one or more computer readable storage media, and program instructions stored on the computer readable storage media for execution by at least one of the one or more processors. The program instructions include program instructions to receive information from a computing device; evaluate the information for asset data, routing information, traffic processing rules, and firewall rules; generate a plain text asset data file, wherein the asset data file comprises an asset record for each possible asset; create, based on the generated plain asset data file, a testing event; and run the testing event.

### BRIEF DESCRIPTION OF THE DRAWINGS

FIG. 1 is a functional block diagram illustrating a computing environment, in accordance with an embodiment of the present invention;

FIG. 2 is a flowchart depicting operational steps of a testing event program, on a computing device within the environment of FIG. 1, in accordance with an embodiment of the present invention; and

FIG. 3 depicts a block diagram of components of the computing device executing the testing event program, in accordance with an embodiment of the present invention.

### DETAILED DESCRIPTION

Embodiments of the present invention recognize how important it is for a security information and event management (SIEM) service to be able to adequately replicate a business's computing network, so that the SIEM service can properly complete network testing and software testing. In some instances, the SIEM service is run by a separate entity that does not have access to the business's network. For example, a business is concerned about protecting its trade secrets, and so the business denies the SIEM service access to its network. Therefore, to replicate the business's network, the business must transfer enormous amounts of data to the SIEM service, such as a replay of network traffic, an export of event traffic, and an asset database. Thus, there is a need for a way to replicate a business's network for software testing and network testing without needing to transfer the large amount of data described and without needing access to a business's network. Embodiments of the present invention provide solutions for replicating a network by generating asset data from small normalized configuration files and telemetry data. In this manner, as discussed in greater detail herein, embodiments of the present invention generate asset data used to create events for SIEM testing and support purposes.

The present invention will now be described in detail with reference to the Figures.

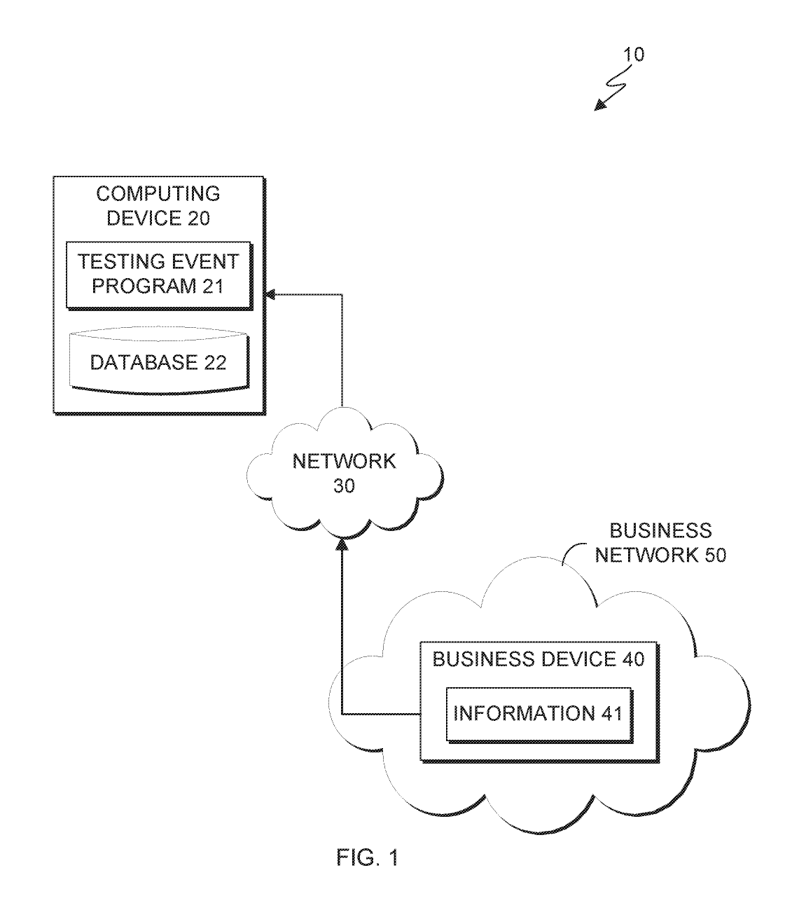

FIG. 1 depicts a diagram of computing environment 10, in accordance with an embodiment of the present invention. FIG. 1 provides only an illustration of one embodiment and does not imply any limitations with regard to the environments in which different embodiments may be implemented.

In the depicted embodiment, computing environment 10 includes computing device 20, network 30, and business network 50 containing business device 40. Computing environment 10 may include additional computing devices, servers, computers, mobile devices, or other devices not shown.

Network 30 operates to allow a business client to send the information 41 needed by a SIEM to replicate the business' network without gaining physical access to business network 50. Network 30 may be a local area network (LAN), a wide area network (WAN) such as the Internet, the public switched telephone network (PSTN), any combination thereof, or any combination of connections and protocols that will support communications between computing device 20 and business device 40, in accordance with embodiments of the invention. Network 30 may include wired, wireless, or fiber optic connections.

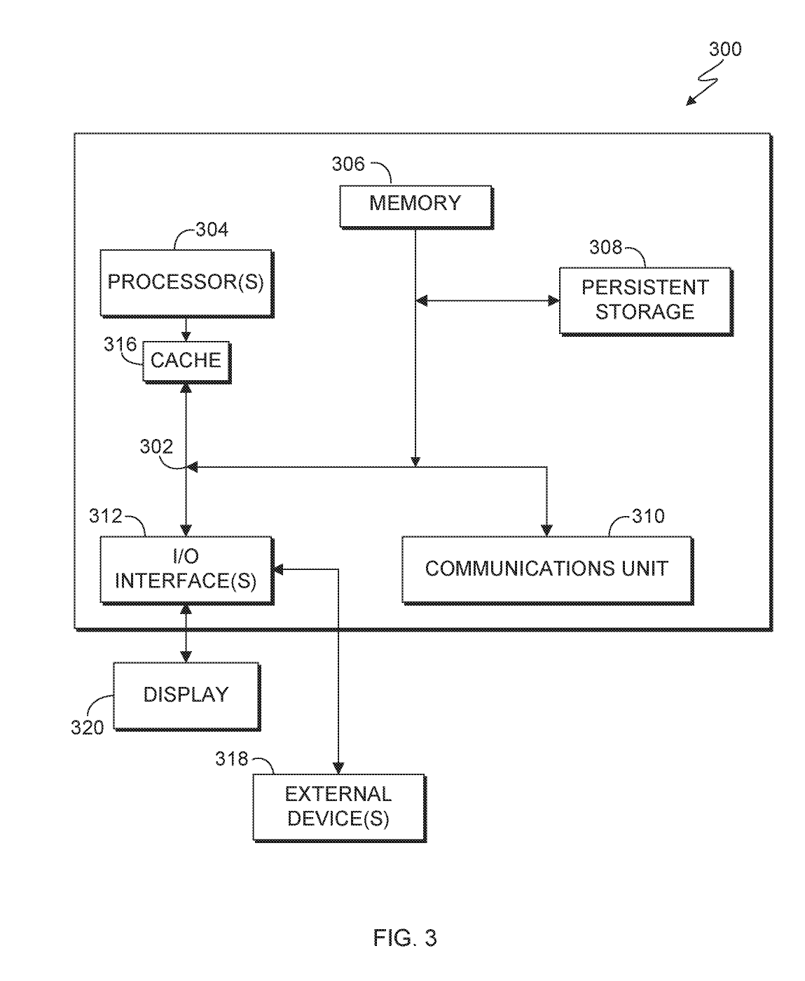

Computing device 20 operates as a part of a SIEM system. Computing device 20 may be a management server, a web server, or any other electronic device or computing system capable of running a program and receiving and sending data. In some embodiments, computing device 20 may be a laptop computer, tablet computer, netbook computer, personal computer (PC), a desktop computer, a smart phone, or any programmable electronic device capable of communicating with business device 40 via network 30. In other embodiments, computing device 20 may represent a server computing system utilizing multiple computers as a server system, such as in a cloud computing environment. In the depicted embodiment, computing device 20 contains testing event program 21 and database 22. Computing device 20 may include components, as depicted and described in further detail with respect to FIG. 3.

Testing event program 21 operates to generate asset data, and then, based on the generated asset data, create an event for software testing or network testing. Testing event program 21 has access to database 22 to store asset data generated from information 41 and to retrieve the asset data for creating testing events. In an embodiment, testing event program 21 evaluates information 41 received from business device 40. Testing event program 21 populates an asset record for each determined possible asset. Testing event program 21 generates a file of asset records that contains each possible asset in plain text format (e.g. .xml). In one embodiment, testing event program 21 creates and runs an event based on the generated file for software testing. In another embodiment, testing event program 21 creates and runs an event based on the generated file for network testing.

Database 22 is a repository for asset data generated by testing event program 21. A database is an organized collection of data. Database 22 can be implemented with any type of storage device capable of storing data and configuration files that can be accessed and utilized by computing device 20, such as a database server, a hard disk drive, or a flash memory. In the depicted embodiment, database 22 resides on computing device 20. In another embodiment, database 22 may reside elsewhere within computing environment 10 provided testing event program 21 has access to database 22. In an embodiment, database 22 is accessed by testing event program 21 to store asset data generated. In another embodiment, database 22 is accessed to use the asset data stored for creating testing events.

Business network 50 operates as a separate network to which a SIEM service running testing event program 21 does not have physical access to. A business, for example, when trying to protect its proprietary information, might not grant the SIEM service access to business network 50. To enable the SIEM service to replicate business network 50, the business would have to transfer enormous amounts of data to the SIEM service, including, but not limited to, a replay of all network traffic, an export of all event traffic, and an asset database. In an embodiment, business network 50 contains business device 40 and information 41. In an embodiment, testing event program 21 replicates business network 50 by generating asset data from small normalized configuration files and telemetry data to create events for SIEM testing and support purposes.

Business device 40 operates as a part of business network 50 and sends information 41 to computing device 20 to be used by testing event program 21. Business device 40 may be a management server, a web server, or any other electronic device or computing system capable of receiving and sending data. In some embodiments, business device 40 may be a laptop computer, tablet computer, netbook computer, personal computer (PC), a desktop computer, a smart phone, or any programmable electronic device capable of communicating with computing device 20 via network 30. In other embodiments, business device 40 may represent a server computing system utilizing multiple computers as a server system, such as in a cloud computing environment. In the depicted embodiment, business device 40 contains information 41. Computing device 20 may include components, as depicted and described in further detail with respect to FIG. 3.

Information 41 includes, but is not limited to, standard element documents, topology records, and telemetry data. Standard element documents (SEDs) are normalized configuration files in plain text format (e.g., .xml) that contain data about a network device. SEDs contain firewall rules (e.g., accept, deny, none, forward), routing information, device information (e.g., type, manufacturer, version), and additional metadata from business device 40. A topology record is the arrangement of the various elements of a computer network. Here, the topology is a visual representation of business network 50 based on configuration information contained in the SEDs. Telemetry data is used by dynamic protocols to locate a device or host, in which location refers to the position within a network. Collected telemetry data is used to enhance the positioning, or location, of a device within a network topology by establishing its network neighbors.

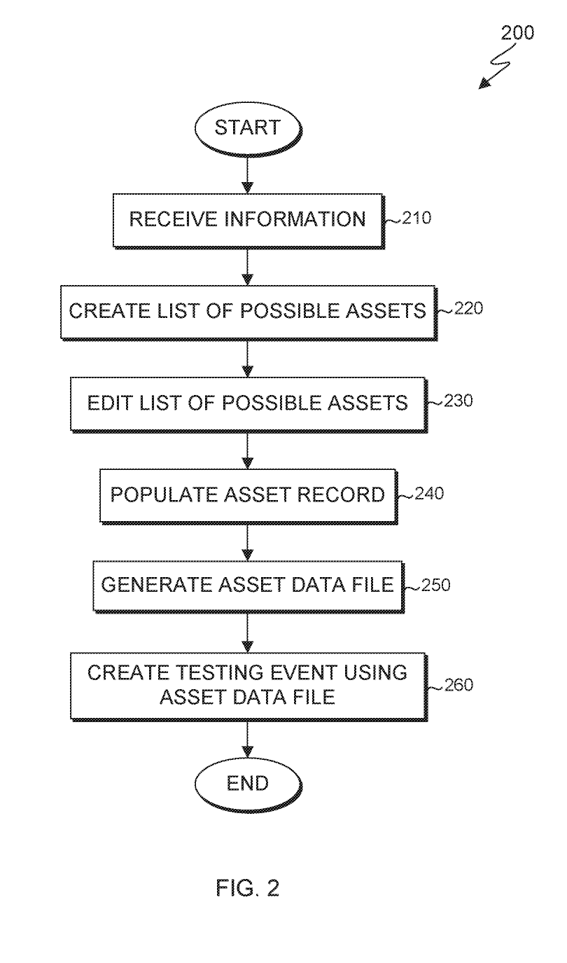

FIG. 2 depicts a flowchart 200 of the steps of testing event program 21, executing within computing environment 10 of FIG. 1, in accordance with an embodiment of the present invention. In the depicted embodiment, testing event program 21 operates to use information 41 to generate an asset data file, and then uses that asset data .xml file to create events for software testing or network testing.

In step 210, testing event program 21 receives information 41. In the depicted embodiment, business device 40 sends information 41 to testing event program 21 on computing device 20. In some embodiments, testing event program 21 requests information 41 from business device 40. In other embodiments, business device 40 sends information 41 without a request from testing event program 21.

In step 220, testing event program 21 creates a list of possible assets. In an embodiment, based on received information 41, testing event program 21 creates a list of possible assets in business network 50. Testing event program 21 creates the list of possible assets by evaluating information 41 for the routing, connected subnets, and firewall rules associated with a device configuration and topology record. Testing event program 21 identifies possible assets that are added to and identified in the list by an IP address, MAC address, hostname, etc. For example, a firewall rule contained in information 41 may be—Source IP: 10.64.1.130/26; Destination IP: 10.64.6.130/26; Port Range: 501-1000; Action: Permit; therefore, any traffic going from the source IP to the destination IP ranges that falls between port 501 and 1000 is permitted traffic and the source IP and destination IP will be included in the list of possible assets. In another example, a firewall rule allows connection to 172.16.100.0/24, which has 255 possible IP addresses in that range, therefore, IP addresses 172.16.100.1 to 172.16.100.255 are included in the list of possible assets.

In step 230, testing event program 21 edits the list of possible assets. In an embodiment, testing event program 21 uses the firewall rules and routing information to eliminate from the list any asset ranges that cannot be reached. For example, if there are firewall rules set to deny traffic to specific internet protocol (IP) addresses or ranges, then those IP addresses or ranges can be eliminated from the list because they cannot be reached. In an embodiment with multiple device configurations, testing event program 21 de-conflicts the firewall rules across the multiple device configurations to determine whether an asset should be on the list. To de-conflict the rules, testing event program 21 looks at each firewall configuration and rules, and determines if assets are possible based on the combined rules across the network. For example, in the case of traffic X from source A to destination B, traffic X must pass through Firewall 1 and Firewall 2. Firewall 1 evaluates traffic X and determines that traffic X is allowed through based on the rules that are contained in the configuration of Firewall 1. Next, traffic X must pass through Firewall 2. Based on the configuration of Firewall 2, traffic X is not allowed through due to a deny rule that contains destination B or the end asset; therefore, the end asset would not be included on the list of possible assets.

In step 240, testing event program 21 populates an asset record. In an embodiment, testing event program 21 populates an asset record for each possible asset in the list. In an embodiment, testing event program 21 includes ports in the asset record for any assets that have specific ports allowed by the firewall rules in information 41. In some embodiments, testing event program 21 adds any common vulnerabilities and exposures (CVE) IDs and associated data about each CVE ID to the asset records of assets that have open ports with known common vulnerabilities or exposures reported. For example, vender A has a vulnerability in its implementation of its operating system on port X, and so the vulnerability has been assigned a CVE ID of 123. In some embodiments, from the information cumulated in an asset record, testing event program 21 infers the asset type and assigns the CVE IDs associated with that asset type to the asset record. In some embodiments, testing event program 21 infers the operating system of each asset from the CVE data. For example, if a large percentage of the vulnerabilities on a specific asset are known to be LINUX® based, then the operating system of a device can be inferred and included in the asset record. In some embodiments, information 41 includes additional information such as the media access control (MAC) address of specific assets, which testing event program 21 evaluates information 41 for and adds to the asset records. When evaluating the MAC information, testing event program 21 uses the MAC addresses included in the SED first, then looks to information contained in the telemetry data.

In step 250, testing event program 21 generates an asset data file in a plain text format (e.g. .xml) of the asset records. In the depicted embodiment, testing event program 21 stores the asset data file in database 22.

In step 260, testing event program 21 creates an event based on the asset data file. In some embodiments, testing event program 21 uses the asset data file combined with the data in the SED to create an event of triggering or violating the traffic processing or firewall rules to test the handling of similar events by a software product. For example, software program A determines that firewall event X is triggered when attempting to access asset Y, so testing event program 21 can create an event to match the network the software will run on. In another embodiment, testing event program 21 uses the asset data file combined with the data in the SED to create an event to test or exercise the offense response workflow within a network. For example, testing event program 21 can create an event triggering rules that have been configured within a SIEM service to notify an operator that specific notable activity is occurring on the network—a SIEM rule creates an offense within the SIEM if the rule that was configured is tripped. In the depicted embodiment, testing event program 21 retrieves the asset data file from database 22.

FIG. 3 is a block diagram depicting components of a computer 300 suitable for executing the testing event program 21. FIG. 3 displays the computer 300, the one or more processor(s) 304 (including one or more computer processors), the communications fabric 302, the memory 306, the cache 316, the persistent storage 308, the communications unit 310, the I/O interfaces 312, the display 320, and the external devices 318. It should be appreciated that FIG. 3 provides only an illustration of one embodiment and does not imply any limitations with regard to the environments in which different embodiments may be implemented. Many modifications to the depicted environment may be made.

As depicted, the computer 300 operates over a communications fabric 302, which provides communications between the cache 316, the computer processor(s) 304, the memory 306, the persistent storage 308, the communications unit 310, and the input/output (I/O) interface(s) 312. The communications fabric 302 may be implemented with any architecture suitable for passing data and/or control information between the processors 304 (e.g. microprocessors, communications processors, and network processors, etc.), the memory 306, the external devices 318, and any other hardware components within a system. For example, the communications fabric 302 may be implemented with one or more buses or a crossbar switch.

The memory 306 and persistent storage 308 are computer readable storage media. In the depicted embodiment, the memory 306 includes a random access memory (RAM). In general, the memory 306 may include any suitable volatile or non-volatile implementations of one or more computer readable storage media. The cache 316 is a fast memory that enhances the performance of computer processor(s) 304 by holding recently accessed data, and data near accessed data, from memory 306.

Program instructions for the testing event program 21 may be stored in the persistent storage 308 or in memory 306, or more generally, any computer readable storage media, for execution by one or more of the respective computer processors 304 via the cache 316. The persistent storage 308 may include a magnetic hard disk drive. Alternatively, or in addition to a magnetic hard disk drive, the persistent storage 308 may include, a solid state hard disk drive, a semiconductor storage device, read-only memory (ROM), electronically erasable programmable read-only memory (EEPROM), flash memory, or any other computer readable storage media that is capable of storing program instructions or digital information.

The media used by the persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of the persistent storage 308.

The communications unit 310, in these examples, provides for communications with other data processing systems or devices. In these examples, the communications unit 310 may include one or more network interface cards. The communications unit 310 may provide communications through the use of either or both physical and wireless communications links. Testing event program 21 may be downloaded to the persistent storage 308 through the communications unit 310. In the context of some embodiments of the present invention, the source of the various input data may be physically remote to the computer 300 such that the input data may be received and the output similarly transmitted via the communications unit 310.

The I/O interface(s) 312 allows for input and output of data with other devices that may operate in conjunction with the computer 300. For example, the I/O interface 312 may provide a connection to the external devices 318, which may include a keyboard, keypad, a touch screen, and/or some other suitable input devices. External devices 318 may also include portable computer readable storage media, for example, thumb drives, portable optical or magnetic disks, and memory cards. Software and data used to practice embodiments of the present invention may be stored on such portable computer readable storage media and may be loaded onto the persistent storage 308 via the I/O interface(s) 312. The I/O interface(s) 312 may similarly connect to a display 320. The display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The term(s) “Linux” and the like may be subject to trademark rights in various jurisdictions throughout the world and are used here only in reference to the products or services properly denominated by the marks to the extent that such trademark rights may exist.

What is claimed is:

1. A method comprising:
receiving, by one or more processors, information from a computing device;
evaluating, by one or more processors, the information for asset data, routing information, traffic processing rules, and firewall rules;
generating, by one or more processors, a plain text asset data file, wherein the asset data file comprises an asset record for each possible asset;
creating, by one or more processors, based on the generated plain asset data file, a testing event; and
running, by one or more processors, the testing event.

2. The method of claim 1, wherein the information comprises normalized device configuration files, topology records, and telemetry data.

3. The method of claim 1, wherein generating a plain text asset data file comprises:
creating, by one or more processors, a list of possible assets;
modifying, by one or more processors, based at least in part on the evaluated information, the list of possible assets; and
populating, by one or more processors, an asset record for each asset.

4. The method of claim 3, wherein modifying the list further comprises eliminating from the list of possible assets an asset range that cannot be reached based on the routing information, traffic processing rules, and firewall rules.

5. The method of claim 3, wherein modifying the list further comprises evaluating any firewall rules and de-conflicting the firewall rules.

6. The method of claim 3, wherein the asset record comprises:
at least one common vulnerabilities and exposures (CVE) identification,
data associated with the CVE identification, and
an operating system type determined from the CVE data.

7. The method of claim 1, wherein the testing event is selected from a group consisting of a network testing event and software testing event, wherein the network testing event is an event to test or exercise the offense response workflow within a network and the software testing event is an event of triggering or violating the traffic processing or firewall rules to test the handling of similar events by a software product.

8. A computer program product comprising:
one or more computer readable storage media and program instructions stored on the one or more computer readable storage media, the program instructions comprising:
program instructions to receive information from a computing device;
program instructions to evaluate the information for asset data, routing information, traffic processing rules, and firewall rules;
program instructions to generate a plain text asset data file, wherein the asset data file comprises an asset record for each possible asset;
program instructions to create, based on the generated plain asset file, a testing event; and
program instructions to run the testing event.

9. The computer claim product of claim 8, wherein the information comprises normalized device configuration files, topology records, and telemetry data.

10. The computer program product of claim 8, wherein the program instructions to generate a plain text asset data file comprise:
program instructions to create a list of possible assets;
program instructions to modify, based at least in part on the evaluated information, the list of possible assets; and
program instructions to populate an asset record for each asset.

11. The computer program product of claim 10, wherein the program instructions to modify the list further comprise program instructions to eliminate from the list of possible assets any asset ranges that cannot be reached based on the routing information and traffic processing and firewall rules.

12. The computer program product of claim 10, wherein the program instructions to modify the list further comprise program instructions to evaluate any firewall rules and de-conflict the firewall rules.

13. The computer program product of claim 10, wherein the asset record comprises:
at least one common vulnerabilities and exposures (CVE) identification,
data associated with the CVE identification, and
an operating system type determined from the CVE data.

14. The computer program product of claim 8, wherein the testing event is selected from a group consisting of a networking testing event and software testing event, wherein the network testing event is an event to test or exercise the offense response workflow within a network and the software testing event is an event of triggering or violating the traffic processing or firewall rules to test the handling of similar events by a software product.

15. A computer system comprising:
one or more computer processors;
one or more computer readable storage media;
program instructions stored on the computer readable storage media for execution by at least one of the one or more processors, the program instructions comprising:
program instructions to receive information from a computing device;
program instructions to evaluate the information for asset data, routing information, traffic processing rules, and firewall rules;
program instructions to generate a plain text asset data file, wherein the asset data file comprises an asset record for each possible asset;
program instructions to create, based on the generated plain asset file, a testing event; and
program instructions to run the testing event.

16. The computer system of claim 15, wherein the information comprises normalized device configuration files, topology records, and telemetry data.

17. The computer system of claim 15, wherein the program instructions to generate a plain text asset data file comprise:
program instructions to create a list of possible assets;
program instructions to modify, based at least in part on the evaluated information, the list of possible assets; and
program instructions to populate an asset record for each asset.

18. The computer system of claim 17, wherein the program instructions to modify the list further comprise program instructions to eliminate from the list of possible assets any asset ranges that cannot be reached based on the routing information and traffic processing and firewall rules.

19. The computer system of claim 17, wherein the program instructions to modify the list further comprise program instructions to evaluate any firewall rules and de-conflict the firewall rules.

20. The computer system of claim 15, wherein the testing event is selected from a group consisting of a networking testing event and software testing event, wherein the network testing event is an event to test or exercise the offense response workflow within a network and the software testing event is an event of triggering or violating the traffic processing or firewall rules to test the handling of similar events by a software product.
